(19) United States
(12) Patent Application Publication
(10) Pub. No.: US 2024/0112681 A1
(43) Pub. Date: Apr. 4, 2024

(54) VOICE BIOMETRICS FOR ANONYMOUS IDENTIFICATION AND PERSONALIZATION

(71) Applicant: Nuance Communications, Inc., Burlington, MA (US)

(72) Inventors: Abhishek ROHATGI, Quebec (CA); Emanuele DALMASSO, Moncalieri (IT); Dinesh SAMTANI, Toronto (CA); Eduardo OLVERA, Phoenix, AZ (US)

(21) Appl. No.: 17/937,351

(22) Filed: Sep. 30, 2022

(51) Int. Cl. G10L 17/06; G10L 17/02; G10L 17/22

(52) U.S. Cl. CPC G10L 17/06; G10L 17/02; G10L 17/22; G08B 5/22

(57) ABSTRACT

Example solutions for voice biometrics for anonymous identification and personalization capture an audio signal containing voice signal from a speaker. A plurality of unlabeled voiceprints are stored that are each associated with an anonymous label. The speaker's voice signal is recognized as matching one of the unlabeled voiceprints, enabling identification of the associated anonymous label. Historical information associated with the identified anonymous label is used to generate an alert specific to the speaker. Example practical applications include leveraging a customer relations management (CRM) interaction record to provide a personalized experience to the speaker and providing a warning to a user that the speaker is on a watchlist. These and other practical applications are possible, even though the speaker's identity may be unknown, and the speaker has not enrolled in a voice biometric system. Solutions for generating the unlabeled voiceprints are also disclosed.

### BACKGROUND

Voice biometrics is currently used in a binary decision: a speaker has either been enrolled and is recognized, or not. When a person enrolls for voice biometric recognition, one or more audio samples containing that person's voice are used to generate a voiceprint. A voiceprint is a digital model of the unique vocal characteristics of that person.

However, this requirement for enrollment limits the use of voice biometrics to scenarios in which a person both has time to register their voice and consents to the use of their voice to create a stored voiceprint. Additionally, the enrollment typically includes personally identifiable information (PII). PII includes information that directly identifies a person, such as name, address, telephone number, email address, or other identifying number or code. Due to the time and permission required for enrollment, for a wide variety of use cases, voice biometrics are currently unavailable for leveraging into proactive and personalized experiences in repeated contacts with the same person, or for fraud prevention.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Example solutions for voice biometrics for anonymous identification and personalization include: capturing a first audio signal containing a first voice signal; determining that the first voice signal matches a first unlabeled voiceprint of a plurality of unlabeled voiceprints that are each associated with an anonymous label, wherein the first unlabeled voiceprint is associated with a first anonymous label; identifying historical information associated with the first anonymous label; and generating an alert indicating the historical information. In some examples, the first audio signal further contains a plurality of voice signals from a plurality of speakers. The historical information with the first unlabeled voiceprint predates capturing the first audio signal.

### BRIEF DESCRIPTION OF THE DRAWINGS

The disclosed examples are described in detail below with reference to the accompanying drawing figures listed below:

FIG. 1 illustrates an example architecture that advantageously provides voice biometrics for anonymous identification and personalization;

FIG. 2 illustrates another example architecture, such as one that supports the architecture of FIG. 1;

FIGS. 3A and 3B illustrate exemplary performance metrics, such as for examples of the architecture of FIG. 1;

FIGS. 4A, 4B, and 4C illustrate an exemplary employment of an example architecture, such as the architecture of FIG. 1, in an engagement with a recognized speaker;

FIG. 5 illustrates another exemplary employment of an architecture, such as the architecture of FIG. 1, in an engagement with a recognized speaker;

FIG. 6 shows a flowchart illustrating exemplary operations that may be performed, such as in examples of the architecture of FIG. 2;

FIG. 7 shows a flowchart illustrating exemplary operations that may be performed, such as in examples of the architecture of FIG. 1;

FIG. 8 shows another flowchart illustrating exemplary operations that may be performed, such as in examples of the architecture of FIG. 1; and

FIG. 9 shows a block diagram of an example computing device suitable for implementing some of the various examples disclosed herein.

Corresponding reference characters indicate corresponding parts throughout the drawings.

### DETAILED DESCRIPTION

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

Example solutions for voice biometrics for anonymous identification and personalization capture an audio signal containing voice signal from a speaker. A plurality of unlabeled voiceprints is stored that are each associated with an anonymous label. The speaker's voice signal is recognized as matching one of the unlabeled voiceprints, enabling identification of the associated anonymous label. Historical information associated with the identified anonymous label is used to generate an alert specific to the speaker. Example practical applications include leveraging a customer relations management (CRM) interaction record to provide a personalized experience to the speaker and providing a warning to a user of the solution that the speaker is on a watchlist. These and other practical applications are possible, even though the speaker's identity may be unknown, and the speaker has not enrolled in a voice biometric system. Solutions for generating the unlabeled voiceprints are also disclosed.

Aspects of the disclosure enhance privacy of speakers by requiring less personally identifiable information (PII) to perform functions that currently require enrollment in a voice biometric solution. Rather than using voice biometrics, anonymous records are used that avoid use of PII, as described herein. Aspects of the disclosure further enhance privacy of speakers by prompting users of the anonymous identification solution to alert speakers and obtain explicit opt-in permission to use the speaker's voice, and permit speakers to opt-out. Thus, permission is obtained from the speaker for use of voice and/or voice recognition information. For example, if a user already has a voiceprint (from having previously opted-in) and grants permission to access the voiceprint, examples of the disclosure further identify and authenticate the speaker, merging previously collected anonymous records to enhance the speaker's user profile.

Aspects of the disclosure improve the operations of computing devices, for example, at least by reducing the memory required for voice biometrics by using unlabeled voiceprints in place of labeled voiceprints that are associated with full speaker enrollment data. Aspects of the disclosure further improve process security and improve user interactions. Improving process security is a result of determining that a first voice signal matches a first unlabeled voiceprint associated with a first anonymous label, identifying historical information associated with the first anonymous label, and generating an alert indicating the historical information. Improving user interaction may occur when the indicated historical information comprises an interaction record, which provides information on a prior interaction with the speaker.

Aspects of the disclosure enable speaker recognition while addressing privacy concerns, at least because a speaker's voice may be matched to a voiceprint that is associated with an anonymous record. A voiceprint is a digital model of the unique vocal characteristics of a speaker, created by processing speech samples. An anonymous record is a record that does not contain any PII. Thus, the speaker is recognized as having been previously encountered, although the speaker's identity is not associated with the voiceprint. In this way, aspects of the disclosure identify a voice and return an alert that the speaker is recognized, without matching the voice to a specific individual. Some examples enhance security when the speaker is recognized as being on a watchlist.

Examples leverage the capture of voice signals which are processed into voiceprints, keep the voiceprints anonymous, and then perform automatic identification from unlabeled audio samples. By recognizing that a speaker's voice is being captured again, a personalized experience may be provided. Alternatively, fraud protection services are enhanced without reaching the point of fully identifying the speaker. Other example applications include recognizing individuals among a group watching a smart TV, or passengers within a vehicle.

Examples may be deployed as part of an ambient listening solution or integrated with equipment that processes or carries voice, or responds to voice commands (e.g., smart TVs, automobiles, and mobile devices). Clustering audio signals captured from speakers may be performed not only by voice characteristics, but also by metadata. This may provide data insights based on different analytics, triggered by aspects such as demography, speaker frequency, and products referenced in a conversation.

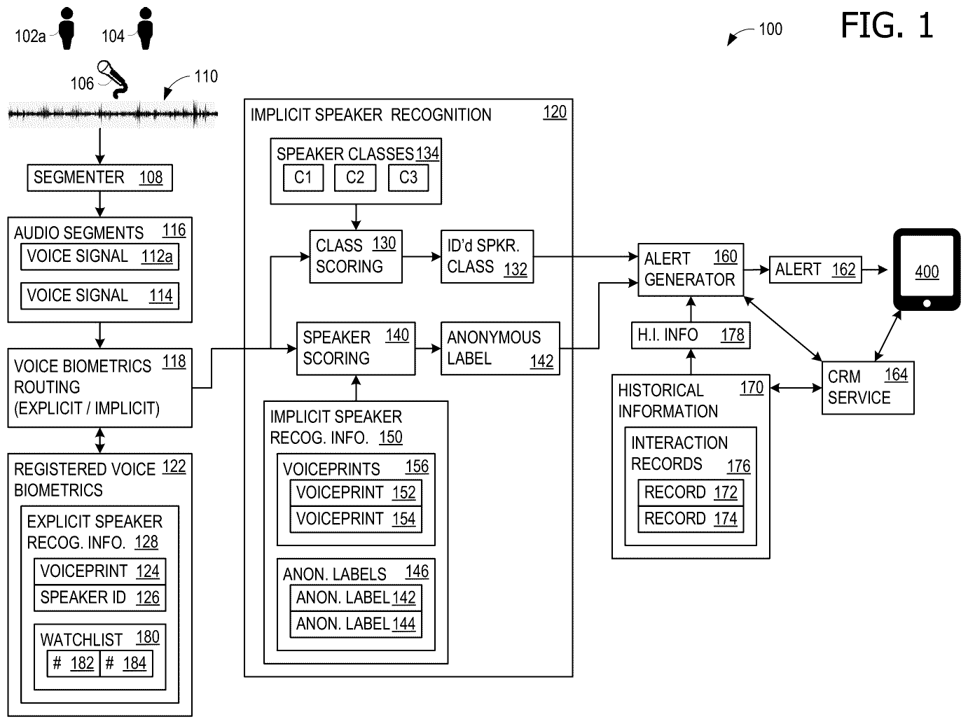

FIG. 1 illustrates an example architecture 100 that advantageously provides voice biometrics for anonymous identification and personalization. In FIG. 1, a first speaker 102a is engaged in a conversation with a known speaker 104. One possible scenario is that speaker 102a is a customer in a store and speaker 104 is a salesperson who works at the store. Speaker 104 is not personally familiar with speaker 102a, although speaker 102a is a repeat customer of the store.

An audio capture device, such as a headset, a mobile phone, a smart speaker, or other device has a microphone 106 that captures an audio signal 110. Audio signal 110 is segmented by audio segmenter 108 into a plurality of audio segments 116. Plurality of audio segments 116 is speaker-specific and includes a voice signal 112a from speaker 102a and a voice signal 114 from speaker 104. Voice signals 112a and 114 are in audio signal 110, as captured by microphone 106. In some examples, audio segmenter 108 retains voice signals 112a and 114 as sampled audio data, although in some examples, audio segmenter 108 processes voice signals 112a and 114 into voiceprints.

Plurality of audio segments 116 is supplied to voice biometric routing 118, which routes selected voice signals to registered voice biometrics 122 and implicit speaker recognition 120. In some situations, speaker 104 may be enrolled in registered voice biometrics 122, because speaker 104 is an employee of the store in the example scenario described above. The enrollment of speaker 104 in registered voice biometrics 122 is leveraged to prevent burdening implicit speaker recognition 120 with attempting to recognize a known speaker whose voice will frequently be encountered by architecture 100.

For example, voice biometrics routing 118 sends both voice signal 112a and voice signal 114 to registered voice biometrics 122. Some examples use speaker diarization, which partitions an input audio stream into homogeneous segments according to the speaker identity. In such examples, audio signal 110 is split, and voice biometrics routing 118 receives separate streams of audio data, one containing voice signal 112a for speaker 102a, and one containing voice signal 114 for speaker 104.

Registered voice biometrics 122 recognizes voice signal 114 by matching voice signal 114 with a labeled voiceprint 124 that is associated with a speaker ID 126. In some examples, registered voice biometrics 122 receives voice signal 112a and voice signal 114 as voiceprints. In some examples, registered voice biometrics 122 processes each of voice signal 112a and voice signal 114 into voiceprints for comparison against stored, previously registered voiceprints. In some examples, the comparison is made using voice signals 112a and 114 remaining as sampled audio data.

In some examples, registered voice biometrics 122 also includes a watchlist 180. Watchlist 180 includes an entry 182 and an entry 184. In some examples, watchlist 180 is a fraud watchlist, and the entries are records of known fraudsters as recognized by voice, although the IDs of the fraudsters may remain unknown and not be included in the records.

Speaker identifier (ID) 126 is the ID of speaker 104, such as a name or another identifier (e.g., employee ID, store number, or other) and is entered into explicit speaker recognition information 128 as part of an enrollment process for speaker 104. When speaker 104 enrolls in registered voice biometrics 122, voice samples from speaker 104 are processed into labeled voiceprint 124, which is stored in explicit speaker recognition information 128, associated with speaker ID 126.

However, registered voice biometrics 122 does not recognize voice signal 112a. Thus, in this described scenario, registered voice biometrics 122 returns an indication to voice biometrics routing 118 that voice signal 112a is not recognized and also returns an indication to voice biometrics routing 118 that voice signal 114 is recognized.

Voice biometrics routing 118 sends only voice signal 112a to implicit speaker recognition 120, in order to attempt recognition of speaker 102a. The operation of implicit speaker recognition 120 acting upon voice signal 112a is described below. It should be noted that some versions of architecture 100 omit registered voice biometrics 122. In such versions, both voice signals 112a and 114 are routed to implicit speaker recognition 120.

Implicit speaker recognition 120 determines voice signal 112a matches an unlabeled voiceprint 152, which is associated with an anonymous label 142. Voice signal 112a is provided to speaker scoring 140, which consults implicit speaker recognition information 150. Implicit speaker recognition information 150 includes a plurality of unlabeled voiceprints 156 and a plurality of anonymous labels 146. Plurality of unlabeled voiceprints 156 includes unlabeled voiceprint 152, an unlabeled voiceprint 152 for another previously encountered speaker, and other voiceprints of additional previously encountered speakers.

Each of the voiceprints in plurality of unlabeled voiceprints 156 is associated with an anonymous label of plurality of anonymous labels 146. Specifically, unlabeled voiceprint 152 is associated with an anonymous label 142, and unlabeled voiceprint 154 is associated with an anonymous label 144. In some examples, an anonymous label is given as “I:0001”, “I:0002”, and so on, which has no semantic meaning.

Speaker scoring 140 matches voice signal 112a against voiceprints in a plurality of unlabeled voiceprints 156 and identifies unlabeled voiceprint 152 as a match. In some examples, speaker scoring 140 comprises a machine learning (ML) model. In some examples, speaker scoring 140 receives voice signal 112a as a voiceprint. In some examples, speaker scoring 140 processes voice signal 112a into a voiceprint for comparison against stored unlabeled voiceprints. In some examples, the comparison is made using voice signal 112a as sampled audio data. By matching voice signal 112a with unlabeled voiceprint 152, anonymous label 142 is identified for speaker 102a.

Voice signal 112a is also provided to class scoring 130, which matches voice signal 112a against speaker classes in a plurality of speaker classes 134. In some examples, class scoring 130 comprises an ML model. A speaker class C1 may be a child speaker class, although a second speaker class C2 and third speaker class C3 are also shown. Class scoring 130 identifies a recognized speaker class 132. In some examples, class scoring 130 leverages a class score based on a library of voiceprints classified into different speaker classes.

Anonymous label 142 and recognized speaker class 132 are provided to an alert generator 160. Alert generator 160 polls historical information library 170 to identify historical information 178 (if any) associated with anonymous label 142. Historical information library 170 includes interaction records 176, which includes an interaction record 172 and an interaction record 174.

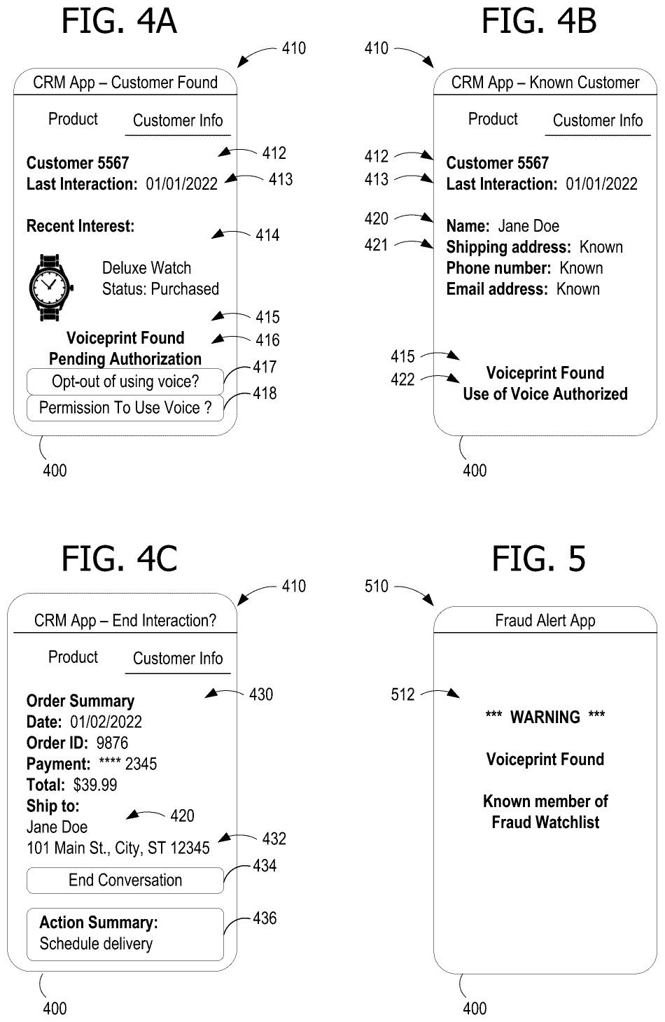

In one scenario, depicted in FIGS. 4A-4C, anonymous label 142 is associated with interaction record 172, indicating that speaker 102a is a returning customer who has made a prior purchase. This renders interaction record 172 a CRM interaction record, which may be leveraged to provide a personalized experience to speaker 102a. Historical information 178 thus includes at least a portion of interaction record 172. Alert generator 160 consults with a CRM service 164 to generate an alert 162 indicating historical information 178.

Alert 162 is sent to a user device 400 being used by speaker 104 (e.g., the store employee). Examples of what speaker 104 sees on user device 400 in this scenario are depicted in FIGS. 4A-4C. In some versions of architecture 100, alert generator 160 sends alert 162 to user device 400, although, in some examples, CRM service 164 sends the information to user device 400. In some examples, CRM service 164 may have the ID of speaker 102a, which may be in interaction record 172. However, the voice biometric functionality of implicit speaker recognition 120 remains anonymous because the speaker ID is not associated with unlabeled voiceprint 152. Any association of an ID with speaker 102a is performed as a separate operation, such as after voiceprint matching has already completed with unlabeled voiceprint 152.

In another scenario, depicted in FIG. 5, anonymous label 142 is associated with watchlist entry 182, indicating that speaker 102a is on watchlist 180. In some examples, watchlist 180 is a fraud watchlist, and the entries are records of known fraudsters as recognized by voice, although the IDs of the fraudsters may remain unknown and not be included in the records. Alert 162 is sent to a user device 400 being used by speaker 104 (e.g., the store employee). Examples of what speaker 104 sees on user device 400 in this scenario are depicted in FIG. 5.

In another scenario, independently of whether anonymous label 142 is associated with any historical information, speaker 102a is identified as being a child using recognized speaker class 132. This occurs when voice signal 112a matches a child speaker class (e.g., speaker class C1). Alert generator 160 generates alert 162 associated with the identified speaker class, and which is sent to user device 400. Speaker 104 may have certain obligations, restrictions, and/or limitations regarding interactions with children, for example, enhanced privacy requirements or other processes to protect the children. Architecture 100 thus provides a significant benefit by alerting speaker 104 (e.g., the store employee) of this situation.

Historical information library 170, implicit speaker recognition 120, and registered voice biometrics 122, and other components of architecture 100 are stored and processed securely, in order to minimize risk of unauthorized disclosure of information regarding any of the speakers.

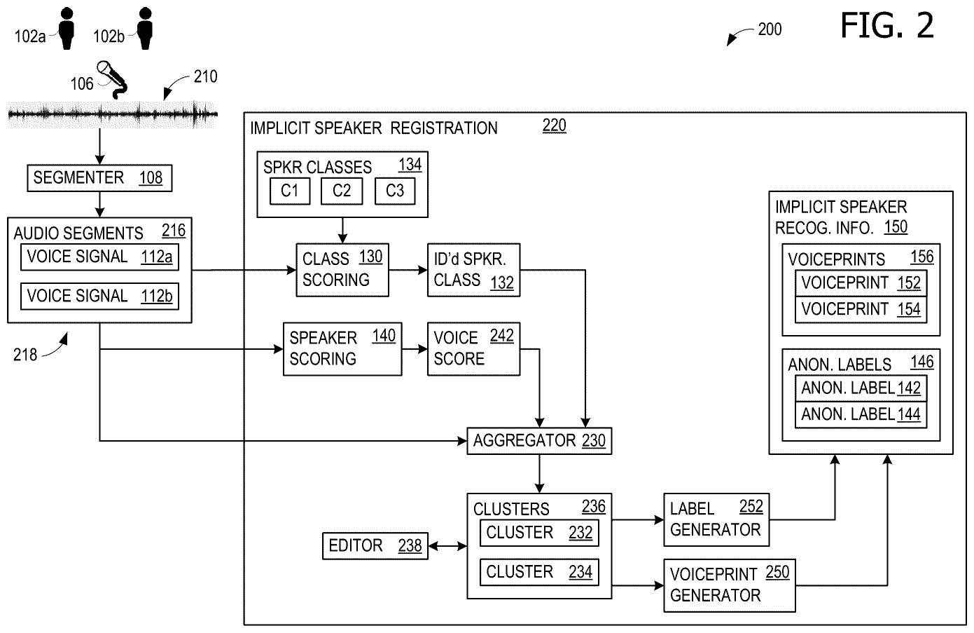

FIG. 2 illustrates architecture 200 that supports architecture 100 by using an implicit speaker registration 220 to build implicit speaker recognition information 150. Architecture 100 is then able to use implicit speaker recognition information 150, as described above. In operation, architecture 200 is employed first to build an initial version of implicit speaker recognition information 150, and then may continue operating in parallel with architecture 100 to further enhance implicit speaker recognition information 150.

A first scenario is described in which speaker 102a and speaker 102b visit the location where architecture 100 is deployed, at a prior time than the scenarios described for FIG. 1. Microphone 106 captures an audio signal 210, which is segmented by audio segmenter 108 into a plurality of audio segments 216. Plurality of audio segments 216 is speaker-specific and includes a plurality of voice signals 218: voice signal 112a from speaker 102a and a voice signal 112b from speaker 102b. Voice signals 112a and 112b are in audio signal 210, as captured by microphone 106, although in some variations of this scenario, microphone 106 captures multiple audio signals, one or more with voice signal 112a, and a different one or more with voice signal 112b. Multiple voice signals may be captured from each speaker.

Class scoring 130 matches voice signals 112a and 112b against speaker classes in a plurality of speaker classes 134 and identifies recognized speaker class 132 for each. Speaker scoring 140 generates a biometric voice score 242 for each of voice signals 112a and 112b. Voice signals 112a and 112b are provided to aggregator 230, along with each voice signal's corresponding biometric voice score 242 and recognized speaker class 132. Other voice signals, and their corresponding biometric voice scores 242 and recognized speaker classes 132 are also provided.

Aggregator 230 clusters the set of received voice signals, including voice signals 112a and 112b, into a plurality of voice signal clusters 236. In some examples, aggregator 230 comprises an ML model. Clustering algorithms for audio signals are known in the art. Each voice signal cluster is the set of all voice signals, as received and retained by aggregator 230, that aggregator 230 postulates belong to a single speaker. Plurality of voice signal clusters 236 includes a voice signal cluster 232 of all voice signals that aggregator 230 postulates belong to a single first speaker, and also a voice signal cluster 234 of all voice signals that aggregator 230 postulates belong to a single second speaker different than the first speaker. In this described scenario, voice signal cluster 232 is the set of all voice signals captured from speaker 102a, including voice signal 112a, and voice signal cluster 234 is the set of all voice signals captured from speaker 102b, including voice signal 112b.

A voiceprint generator 250 generates unlabeled voiceprint 152 from voice signal cluster 232 and generates unlabeled voiceprint 154 from voice signal cluster 234. A label generator 252 generates anonymous label 142 and associates it with unlabeled voiceprint 152 and generates anonymous label 144 and associates it with unlabeled voiceprint 154. Speakers 102a and 102b are now implicitly registered anonymously, so that architecture 100 is able to recognize having encountered them. This is accomplished by implicit speaker registration 220 without requiring an explicit voice biometric enrollment.

Another scenario is described in which speaker 102a and speaker 102b visit the location where architecture 100 is deployed, at a later time than the scenarios described for FIG. 1. Implicit speaker registration information 150 already exists and has been initially populated. However, upon collecting further voice signals from speakers 102a and 102b, the voice signals are passed implicit speaker registration 220 which adds the newly captured voice signals to the proper one of voice signal cluster 232 and 234. For example, voice signal cluster 232 is associated with speaker 102a and voice signal cluster 234 is associated with speaker 102b. The next time voiceprints are generated, it is with the additional voice signals in the voice clusters, providing potentially superior voiceprints.

In some scenarios, a user of architecture 100 may notice errors in alerts 162, such as different speakers being incorrectly identified as a single speaker, and/or a single speaker being incorrectly identified alternately as different speakers. An editor 238 is provided that enables a user to edit plurality of voice signal clusters 236. The user may force a merge of different clusters or delete a cluster that generated a superfluous voiceprint. These actions may result in eliminating the alternate recognitions for a single speaker. In some scenarios, deleting a cluster that is producing a voiceprint that is incorrectly being attributed to different speakers results in new clustering using future voice signals that may correct the problem.

In some examples, a cluster may not be deleted, but instead disabled, so that it is no longer used for assigning voiceprints. In some examples, a cluster may be added to watchlist 180, if the interaction with the speaker is recognized as being a fraud attempt.

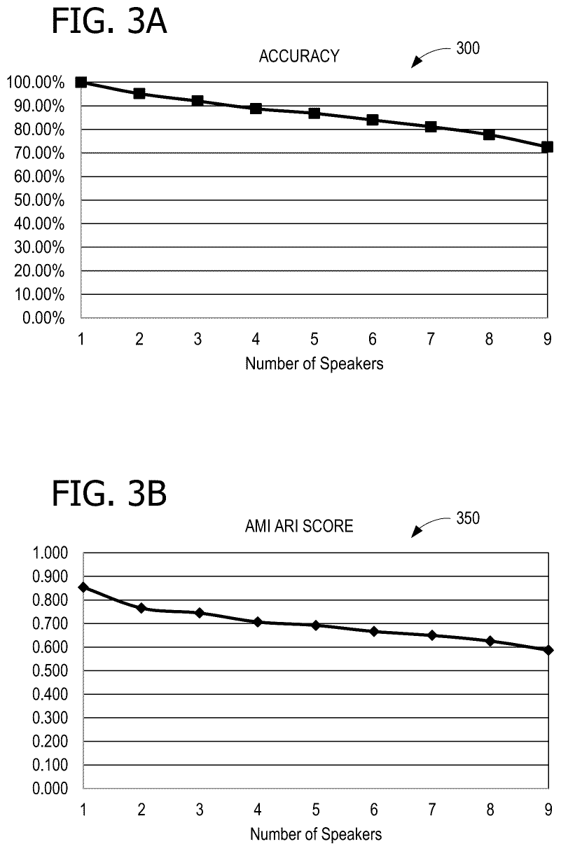

FIG. 3A shows a graph 300 of speaker identification accuracy as a function of the number of speakers, for example implementations of architectures 100 and 200. As indicated, when there is only a single speaker, accuracy is 100%, although when there are nine speakers, the implemented example dropped to approximately 80% accuracy in correctly identifying the speaker.

FIG. 3B shows a graph 350 of a performance metric as a function of the number of speakers, for example implementations of architectures 100 and 200. The performance metric is the average of adjusted mutual information (AMI) and adjusted rand index (ARI). AMI and ARI are known metrics for evaluating the quality of clusters, with higher values indicating superior performance. As indicated, the metric scores are higher for fewer speakers.

FIG. 4A illustrates a screen of a CRM application 410 executing on user device 400, when alert 162 is first received that speaker 1-2a is recognized. A customer identifier 412, which may be anonymous label 142, or another label supplied by CRM service 164 is displayed, along with a date 413 of the last recorded interaction (e.g., a data associated with interaction record 172). An indication 414 of a prior-purchased product is provided, so that the store employee (e.g., speaker 104) is able to provide a personalized experience to speaker 102a, for example by inquiring how satisfied speaker 102a is with the purchase. An indication 415 alerts the store employee that the speaker's voiceprint (e.g., unlabeled voiceprint 152) is found. Another indication 416 indicates that using the voice of speaker 102a is not yet authorized, but is instead pending authorization.

A user interface (UI) element 417 (e.g., a clickable button) is provided to prompt the store employee to alert speaker 102a that their voice is being used for identification and obtain opt-in consent from speaker 102a or opt-out. The store employee clicks UI element 417 to indicate that the speaker has opted-out. Implicit speaker recognition 120 then ceases processing voice information from speaker 102a.

UI element 418 (e.g., another clickable button) is provided record opt-in consent from speaker 102a for use the voice of speaker 102a to pull up CRM information, such as a shipping address. UI element 418 also provides a way for the store employee to indicate that speaker 102a has consented to the use of their voice, by store employee clicking on UI element 418. Thus, an explicit opt-in is supported.

Upon receiving an indication of consent by speaker 102a for the use of their voice, CRM application 410 displays further information on speaker 102a, such as a name 420 and an indication 422 that the shipping address and other contact information for speaker 102a is found within CRM service 164, and not within implicit speaker recognition 120. This is shown in FIG. 4B, but only upon consent by speaker 102a. Name 420 and the shipping address had been collected from speaker 102a previously, for example, for the purpose of shipping merchandise (e.g., the prior-purchased product of indication 414). However, in some examples, for privacy purposes, additional information, such as the shipping address and other contact information are not yet displayed, but there may be an indication that they are already known. Additionally, an indication 422 alerts the store employee that use of the voice of speaker 102a is now authorized.

By storing name 420 and the shipping address and other contact information for speaker 102a within CRM service 164, the current transaction is rendered more convenient for speaker 102a by precluding the need for the store employee to collect it again. Further, the use of architecture 100 simplifies the store employee locating name 420, because the store employee does not need to manually search for information on speaker 102a.

Upon completing the sales transaction, as shown in FIG. 4C, CRM application 410 displays an order summary 430 and shipping address 432 for speaker 102a. A UI element 434 prompts the store employee to terminate the CRM interaction session, which results in the generation of another interaction record associated with anonymous label 142 in historical information 178. Additionally, an action summary 436 prompts the store employee to perform another action related to the interaction with speaker 102a.

FIG. 5 illustrates another exemplary employment scenario of architecture 100, although this time with speaker 102a being found in watchlist 180 as entry 182 by registered voice biometrics 122. Although, in the scenario depicted in FIG. 5, the ID of speaker 102a is not known, the identification of speaker 102a using unlabeled voiceprint 152 enables a watchlist alert application 510 to display a warning 512 based on alert 162. The store employee is then alerted to exercise caution when interacting with speaker 102a.

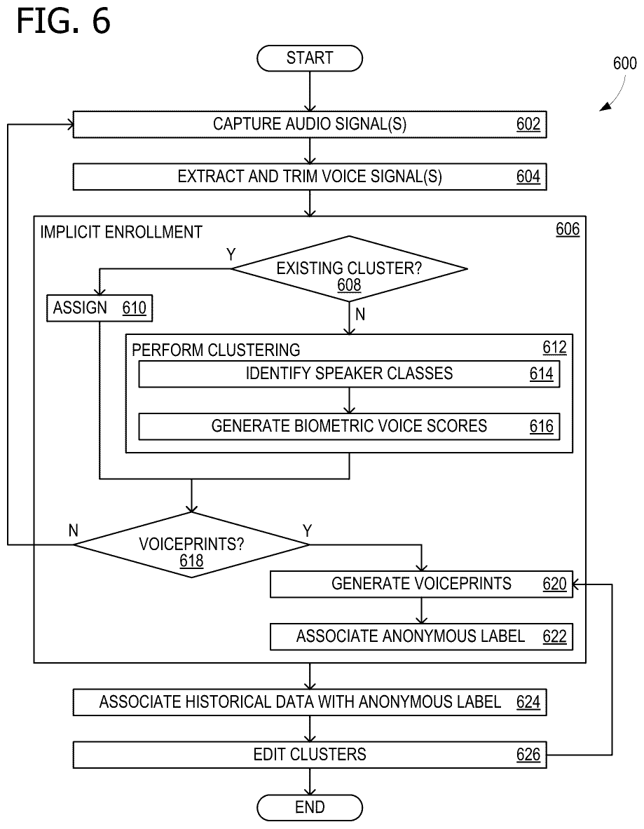

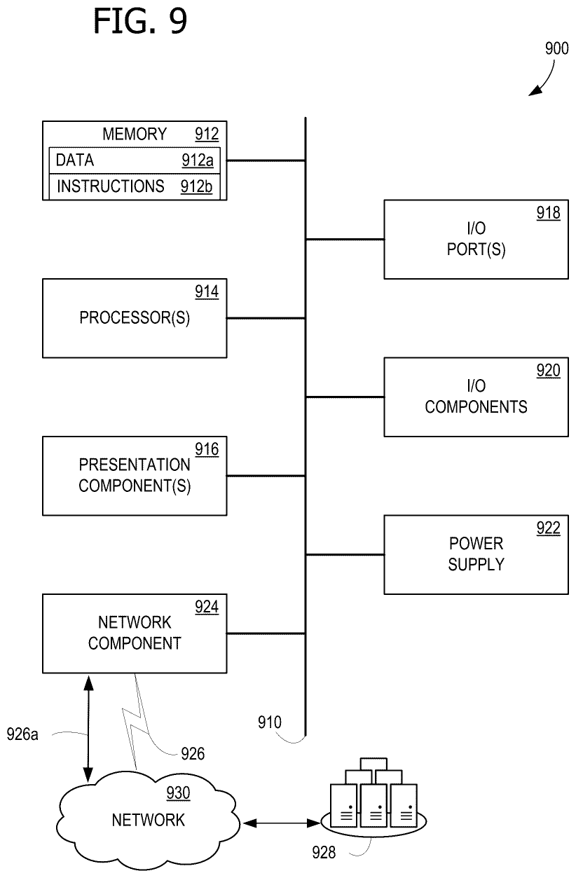

FIG. 6 shows a flowchart 600 illustrating exemplary operations that may be performed by architecture 200. In some examples, operations described for flowchart 600 are performed by computing device 900 of FIG. 9. Flowchart 600 commences with capturing audio signal 210 containing voice signal 112a in operation 602. In some examples, operation 602 further comprises capturing a plurality of audio signals containing a plurality of voice signals 218, such as voice signals 112a and 112b.

Operation 604 trims voice signal 112a to a minimum length needed for clustering. Operation 606 performs implicit enrollment of speakers of the plurality of voice signals 218 using operations 608-622. Implicit enrollment of speakers comprises generating plurality of unlabeled voiceprints 156. Implicit enrollment of speakers further comprises associating an anonymous label with each unlabeled voiceprint of plurality of unlabeled voiceprints 156.

Decision operation 608 determines whether a voice signal matches an existing voice signal cluster. If so, operation 610 assigns the voice signal to the cluster. Otherwise, operation 612 performs clustering of the voice signals using operations 614-616, for example, clustering plurality of voice signals 218 into plurality of voice signal clusters 236. The different voice signal clusters represent different speakers. Operation 614 identifies, for each of plurality of voice signals 218, from plurality of speaker classes 134, recognized speaker class 132. Operation 616 generates, for each of plurality of voice signals 218, biometric voice score 242. In some examples, one score is generated for each voice signal, although other methods are contemplated. For example, some voice signals may be grouped for scoring purposes. In some examples, clustering the plurality of voice signals further comprises generating an estimate of a count of different speakers.

Decision operation 618 determines whether to generate a new version of plurality of unlabeled voiceprints 156. In some examples, this includes determining whether a new voice signal cluster within plurality of voice signal clusters 236 lacks a voiceprint. If all of the voice signal clusters have a corresponding voiceprint that is not past a certain age, or there is not a threshold number of voice signal clusters lacking a corresponding voiceprint, then generating voiceprints may be delayed. In such a situation, flowchart 600 returns to operation 602 to capture more audio signals with voices.

Otherwise, in some examples, operation 620 generates, for each voice signal cluster, an unlabeled voiceprint. Plurality of unlabeled voiceprints 156 comprises the voiceprints generated for the voice signal clusters of plurality of voice signal clusters 236. None of plurality of unlabeled voiceprints 156 is associated with PII; for example, none of plurality of unlabeled voiceprints 156 is associated with a speaker's ID. In some examples, operation 620 includes, based on at least determining that a new voice signal cluster lacks a voiceprint, generating, for the new voice signal cluster, a new unlabeled voiceprint, and appending plurality of unlabeled voiceprints 156 with the new unlabeled voiceprint.

Operation 622 associates an anonymous label with each unlabeled voiceprint of plurality of unlabeled voiceprints 156. In some scenarios, a new voiceprint is appended to plurality of unlabeled voiceprints 156, rather than plurality of unlabeled voiceprints 156 being generated anew. In such scenarios, operation 622 assigns, to the new unlabeled voiceprint, a new anonymous label. Operation 624 associates available historical information with the various anonymous labels, such as associating historical information 178 with anonymous label 142.

In operation 626, a user edits plurality of voice signal clusters 236, for example to merge voice signal clusters or delete a voice signal cluster, if necessary to improve the speaker recognition performance. Based on the extent of the editing, flowchart 600 either terminates or returns to operation 620.

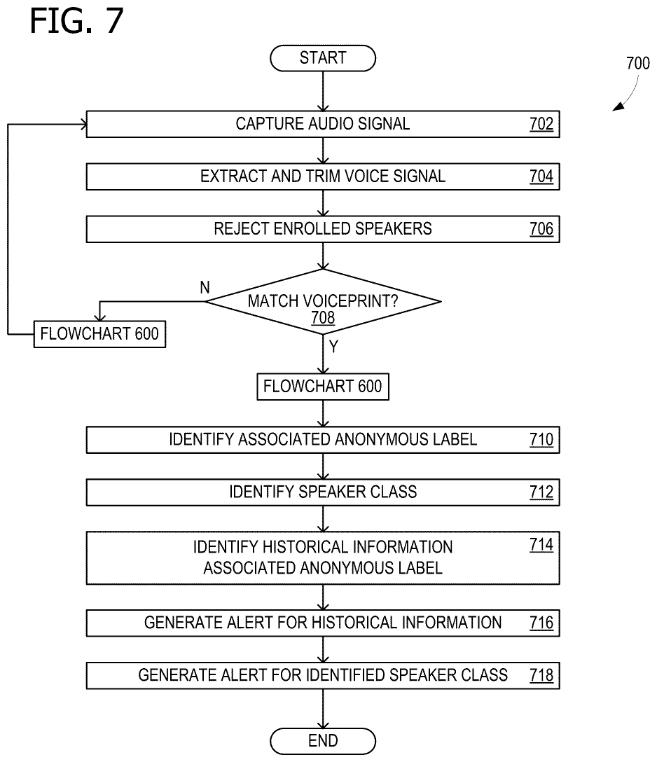

FIG. 7 shows a flowchart 700 illustrating exemplary operations that may be performed by architecture 100. In some examples, operations described for flowchart 700 are performed by computing device 900 of FIG. 9. Flowchart 700 commences with capturing audio signal 110 containing voice signal 112a, in operation 702. In some examples, audio signal 110 contains a plurality of voice signals from a plurality of speakers. The association of historical information 178 with unlabeled voiceprint 152 in operation 624 of flowchart 600 predates capturing audio signal 110 in operation 702 of flowchart 700. Decision operation 703 provides the speaker the opportunity to opt-out, for example by the user clicking UI element 417.

Operation 704 extracts and trims the voice signals to the minimum length needed for reliable speaker recognition. Operation 706 rejects enrolled speakers from the speaker recognition performed in operations 708-712. If performed, operation 706 identifies voice signal 114 within audio signal 110 and determines that voice signal 114 matches voiceprint 124, which is a labeled voiceprint. Some examples do not use operation 706 and enrollment of speakers who are continually in the presence of architecture 100.

Decision operation 708 determines whether voice signal 112a matches any voiceprint of plurality of unlabeled voiceprints 156. If not, flowchart 700 diverts through flowchart 600 and then returns to operation 702. While within this diversion through flowchart 600, based on at least determining that voice signal 112a does not match any voiceprint of plurality of unlabeled voiceprints 156, operation 612 clusters voice signal 112a into plurality of voice signal clusters 236.

If a voiceprint match is found (e.g., unlabeled voiceprint 152), some examples of flowchart 700 also divert through flowchart 600 in order to update, improve, or otherwise adjust unlabeled voiceprint 152 with voice signal 112a. That is, based on at least determining that voice signal 112a matches unlabeled voiceprint 152, unlabeled voiceprint 152 is updated with voice signal 112a. Although in this branch, after diverting through flowchart 600, flowchart 700 proceeds to operation 710 to identify associated anonymous label 142 that is matched with unlabeled voiceprint 152.

Operation 712 identifies, for voice signal 112a, from plurality of speaker classes 134, recognized speaker class 132. In some scenarios, recognized speaker class 132 comprises a speaker age group, such as identifying that speaker 102a is a child. Operation 714 identifies historical information 178 associated with anonymous label 142. In some examples, historical information 178 displayed about a speaker include an interaction record (e.g., interaction record 172). In some examples, the watchlist comprises a fraud watchlist. In some examples, the interaction record comprises product or service inquiry information. In some examples, the interaction record comprises a CRM record.

Operation 716 generates alert 162 indicating historical information 178. In addition, or instead, operation 718 generates alert 162 associated with recognized speaker class 132. In some examples, when alert 162 is associated with recognized speaker class 132, it comprises a generic user customization, such as responding to a customer being a minor child, rather than an adult. In some examples, alert 162 is instead an alert from registered voice biometrics 122 indicating that the speaker is recognized to be in a watchlist (e.g., watchlist 180).

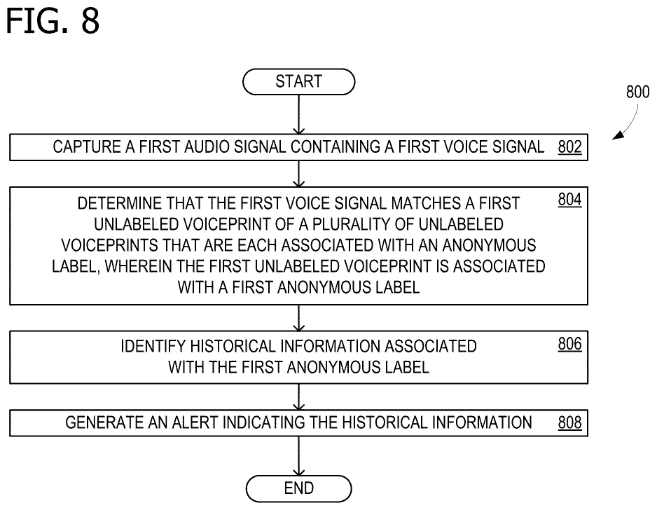

FIG. 8 shows a flowchart 800 illustrating exemplary operations that may be performed by architecture 100. In some examples, operations described for flowchart 800 are performed by computing device 900 of FIG. 9. Flowchart 800 commences with operation 802, which includes capturing a first audio signal containing a first voice signal. Operation 804 includes determining that the first voice signal matches a first unlabeled voiceprint of a plurality of unlabeled voiceprints that are each associated with an anonymous label, wherein the first unlabeled voiceprint is associated with a first anonymous label. Operation 806 includes identifying historical information associated with the first anonymous label. Operation 808 includes generating an alert indicating the historical information.

### Additional Examples

An example system comprises: a processor; and a computer-readable medium storing instructions that are operative upon execution by the processor to: capture a first audio signal containing a plurality of voice signals from a plurality of speakers, including a first voice signal; determine that the first voice signal matches a first unlabeled voiceprint of a plurality of unlabeled voiceprints that are each associated with an anonymous label, wherein the first unlabeled voiceprint is associated with a first anonymous label; identify historical information associated with the first anonymous label; and generate an alert indicating the historical information.

An example computerized method comprises: capturing a first audio signal containing a first voice signal; determining that the first voice signal matches a first unlabeled voiceprint of a plurality of unlabeled voiceprints that are each associated with an anonymous label, wherein the first unlabeled voiceprint is associated with a first anonymous label; identifying historical information associated with the first anonymous label; and generating an alert indicating the historical information.

One or more example computer storage devices have computer-executable instructions stored thereon, which, on execution by a computer, cause the computer to perform operations comprising: capturing a first audio signal containing a first voice signal; determining that the first voice signal matches a first unlabeled voiceprint of a plurality of unlabeled voiceprints that are each associated with an anonymous label, wherein the first unlabeled voiceprint is associated with a first anonymous label; identifying historical information associated with the first anonymous label, wherein the association of the historical information with the first unlabeled voiceprint predates capturing the first audio signal; and generating an alert indicating the historical information.

Alternatively, or in addition to the other examples described herein, examples include any combination of the following:
capturing a plurality of audio signals containing a plurality of voice signals;
clustering the plurality of voice signals into a plurality of voice signal clusters;
generating, for each voice signal cluster, an unlabeled voiceprint;
the plurality of unlabeled voiceprints comprises the voiceprints generated for the voice signal clusters;
associating an anonymous label with each unlabeled voiceprint of the plurality of unlabeled voiceprints;
determining whether the first voice signal matches any voiceprint of the plurality of unlabeled voiceprints;
based on at least determining that the voice signal does not match any voiceprint of the plurality of unlabeled voiceprints, clustering the voice signal among the plurality of voice signals into the plurality of voice signal clusters;
determining whether a new voice signal cluster within the plurality of voice signal clusters lacks a voiceprint;
based on at least determining that the new voice signal cluster lacks a voiceprint: generating, for the new voice signal cluster, a new unlabeled voiceprint, and appending the plurality of unlabeled voiceprints with the new unlabeled voiceprint;
clustering the plurality of voice signals comprises identifying, for each of the plurality of voice signals, from a plurality of speaker classes, an identified speaker class;
clustering the plurality of voice signals further comprises generating, for each of the plurality of voice signals, a biometric voice score;
clustering the plurality of voice signals further comprises generating an estimate of a count of different speakers;
identifying, for the first voice signal, from a plurality of speaker classes, an identified speaker class;
generating an alert associated with the identified speaker class;
based on at least determining that the voice signal matches the first unlabeled voiceprint, updating the first unlabeled voiceprint with the voice signal;
the first audio signal contains a plurality of voice signals from a plurality of speakers;
assigning, to the new unlabeled voiceprint, a new anonymous label;
associating the historical information with the first anonymous label;
the association of the historical information with the first unlabeled voiceprint predates capturing the first audio signal;
none of the plurality of unlabeled voiceprints is associated with PII;
none of the plurality of unlabeled voiceprints is associated with a speaker's name;
generating an alert indicating that the first voice signal is associated with a speaker included in a watchlist;
the watchlist comprises a fraud watchlist;
the interaction record comprises product or service inquiry information;
the interaction record comprises a CRM record;
the identified speaker class comprises a speaker age group;
the alert associated with the identified speaker class comprises a generic user customization;
merging voice signal clusters;
editing the plurality of voice signal clusters to merge voice signal clusters;
deleting a voice signal cluster;
editing the plurality of voice signal clusters to delete a voice signal cluster;
identifying a second voice signal within the first audio signal;
determining that the second voice signal matches a second voiceprint;
the second voiceprint is labeled;
the second voiceprint is unlabeled;
performing implicit enrollment of speakers of the plurality of voice signals;
the implicit enrollment of speakers comprises generating the plurality of unlabeled voiceprints; and
the implicit enrollment of speakers further comprises associating an anonymous label with each unlabeled voiceprint of the plurality of unlabeled voiceprints.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 9 is a block diagram of an example computing device 900 (e.g., a computer storage device) for implementing aspects disclosed herein, and is designated generally as computing device 900. In some examples, one or more computing devices 900 are provided for an on-premises computing solution. In some examples, one or more computing devices 900 are provided as a cloud computing solution. In some examples, a combination of on-premises and cloud computing solutions are used. Computing device 900 is but one example of a suitable computing environment and is not intended to suggest any limitation as to the scope of use or functionality of the examples disclosed herein, whether used singly or as part of a larger set.

Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 910 that directly or indirectly couples the following devices: computer storage memory 912, one or more processors 914, one or more presentation components 916, input/output (I/O) ports 918, I/O components 920, a power supply 922, and a network component 924. While computing device 900 is depicted as a seemingly single device, multiple computing devices 900 may work together and share the depicted device resources. For example, memory 912 may be distributed across multiple devices, and processor(s) 914 may be housed with different devices.

Bus 910 represents what may be one or more busses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 912 may take the form of the computer storage media referenced below and operatively provide storage of computer-readable instructions, data structures, program modules and other data for the computing device 900. In some examples, memory 912 stores one or more of an operating system, a universal application platform, or other program modules and program data. Memory 912 is thus able to store and access data 912a and instructions 912b that are executable by processor 914 and configured to carry out the various operations disclosed herein.

In some examples, memory 912 includes computer storage media. Memory 912 may include any quantity of memory associated with or accessible by the computing device 900. Memory 912 may be internal to the computing device 900 (as shown in FIG. 9), external to the computing device 900 (not shown), or both (not shown). Additionally, or alternatively, the memory 912 may be distributed across multiple computing devices 900, for example, in a virtualized environment in which instruction processing is carried out on multiple computing devices 900. For the purposes of this disclosure, “computer storage media,” “computer-storage memory,” “memory,” and “memory devices” are synonymous terms for memory 912, and none of these terms include carrier waves or propagating signaling.

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represent an implementation of analog techniques to perform the operations described herein. For example, the operations may be performed by an analog client computing device 900 and/or a digital client computing device 900. Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 918 allow computing device 900 to be logically coupled to other devices including I/O components 920, some of which may be built in. Example I/O components 920 include, for example but without limitation, a microphone, joystick, game pad, satellite dish, scanner, printer, wireless device, etc.

Computing device 900 may operate in a networked environment via the network component 924 using logical connections to one or more remote computers. In some examples, the network component 924 includes a network interface card and/or computer-executable instructions (e.g., a driver) for operating the network interface card. Communication between the computing device 900 and other devices may occur using any protocol or mechanism over any wired or wireless connection. In some examples, network component 924 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 924 communicates over wireless communication link 926 and/or a wired communication link 926a to a remote resource 928 (e.g., a cloud resource) across network 930. Various different examples of communication links 926 and 926a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
capture a first audio signal containing a plurality of voice signals from a plurality of speakers, including a first voice signal;
determine that the first voice signal matches a first unlabeled voiceprint of a plurality of unlabeled voiceprints that are each associated with an anonymous label, wherein the first unlabeled voiceprint is associated with a first anonymous label;
identify historical information associated with the first anonymous label; and
generate an alert indicating the historical information.

2. The system of claim 1, wherein the instructions are further operative to:
capture a plurality of audio signals containing a plurality of voice signals;
cluster the plurality of voice signals into a plurality of voice signal clusters;
generate, for each voice signal cluster, an unlabeled voiceprint, wherein the plurality of unlabeled voiceprints comprises the voiceprints generated for the voice signal clusters; and
associate an anonymous label with each unlabeled voiceprint of the plurality of unlabeled voiceprints.

3. The system of claim 2, wherein the instructions are further operative to:
determine whether the first voice signal matches any voiceprint of the plurality of unlabeled voiceprints;
based on at least determining that the voice signal does not match any voiceprint of the plurality of unlabeled voiceprints, cluster the voice signal among the plurality of voice signals into the plurality of voice signal clusters;
determine whether a new voice signal cluster within the plurality of voice signal clusters lacks a voiceprint; and
based on at least determining that the new voice signal cluster lacks a voiceprint:
generate, for the new voice signal cluster, a new unlabeled voiceprint; and
append the plurality of unlabeled voiceprints with the new unlabeled voiceprint.

4. The system of claim 1, wherein the instructions are further operative to:
identify a second voice signal within the first audio signal; and
determine that the second voice signal matches a second voiceprint.

5. The system of claim 1, wherein the instructions are further operative to:
identifying, for the first voice signal, from a plurality of speaker classes, an identified speaker class; and
generating an alert associated with the identified speaker class.

6. The system of claim 1, wherein the instructions are further operative to:
based on at least determining that the voice signal matches the first unlabeled voiceprint, updating the first unlabeled voiceprint with the voice signal.

7. The system of claim 1, wherein the instructions are further operative to:
generate an alert indicating that the first voice signal is associated with a speaker included in a watchlist.

8. A computerized method comprising:
capturing a first audio signal containing a first voice signal;
determining that the first voice signal matches a first unlabeled voiceprint of a plurality of unlabeled voiceprints that are each associated with an anonymous label, wherein the first unlabeled voiceprint is associated with a first anonymous label;
identifying historical information associated with the first anonymous label; and
generating an alert indicating the historical information.

9. The computerized method of claim 8, further comprising:
capturing a plurality of audio signals containing a plurality of voice signals;
clustering the plurality of voice signals into a plurality of voice signal clusters;
generating, for each voice signal cluster, an unlabeled voiceprint, wherein the plurality of unlabeled voiceprints comprises the voiceprints generated for the voice signal clusters; and
associating an anonymous label with each unlabeled voiceprint of the plurality of unlabeled voiceprints.

10. The computerized method of claim 9, further comprising:
determining whether the first voice signal matches any voiceprint of the plurality of unlabeled voiceprints;
based on at least determining that the voice signal does not match any voiceprint of the plurality of unlabeled voiceprints, clustering the voice signal among the plurality of voice signals into the plurality of voice signal clusters;
determining whether a new voice signal cluster within the plurality of voice signal clusters lacks a voiceprint; and
based on at least determining that the new voice signal cluster lacks a voiceprint:
generating, for the new voice signal cluster, a new unlabeled voiceprint; and
appending the plurality of unlabeled voiceprints with the new unlabeled voiceprint.

11. The computerized method of claim 9, wherein clustering the plurality of voice signals comprises:
identifying, for each of the plurality of voice signals, from a plurality of speaker classes, an identified speaker class; and
generating, for each of the plurality of voice signals, a biometric voice score.

12. The computerized method of claim 8, further comprising:
identifying, for the first voice signal, from a plurality of speaker classes, an identified speaker class; and
generating an alert associated with the identified speaker class.

13. The computerized method of claim 8, further comprising:
based on at least determining that the voice signal matches the first unlabeled voiceprint, updating the first unlabeled voiceprint with the voice signal.

14. The computerized method of claim 8, further comprising:
generating an alert indicating that the first voice signal is associated with a speaker included in a watchlist.

15. One or more computer storage devices having computer-executable instructions stored thereon, which, on execution by a computer, cause the computer to perform operations comprising:
capturing a first audio signal containing a first voice signal;
determining that the first voice signal matches a first unlabeled voiceprint associated with a first anonymous label;
identifying historical information associated with the first anonymous label, wherein the association of the historical information with the first unlabeled voiceprint predates capturing the first audio signal; and
generating an alert indicating the historical information.

16. The one or more computer storage devices of claim 15, wherein the operations further comprise:
capturing a plurality of audio signals containing a plurality of voice signals;
clustering the plurality of voice signals into a plurality of voice signal clusters;
generating, for each voice signal cluster, an unlabeled voiceprint, wherein a plurality of unlabeled voiceprints comprises the voiceprints generated for the voice signal clusters; and
associating an anonymous label with each unlabeled voiceprint of the plurality of unlabeled voiceprints.

17. The one or more computer storage devices of claim 16, wherein the operations further comprise:
deleting a voice signal cluster.

18. The one or more computer storage devices of claim 16, wherein clustering the plurality of voice signals comprises:
identifying, for each of the plurality of voice signals, from a plurality of speaker classes, an identified speaker class; and
generating, for each of the plurality of voice signals, a biometric voice score.

19. The one or more computer storage devices of claim 15, wherein the operations further comprise:
identifying, for the first voice signal, from a plurality of speaker classes, an identified speaker class; and
generating an alert associated with the identified speaker class.

20. The one or more computer storage devices of claim 15, wherein the operations further comprise:
based on at least determining that the voice signal matches the first unlabeled voiceprint, updating the first unlabeled voiceprint with the voice signal.
